(19) United States
(12) Patent Application Publication
(10) Pub. No.: US 2003/0022583 A1
(43) Pub. Date: Jan. 30, 2003

(54) Ballstic resistant fabric

(76) Inventors: Howard L. Thomas, Palmgra, VA (US); Greg J. Thompson, Greenville, SC (US)

Correspondence Address: Sheldon H. Parker, Suite 100, 250 West Main Street, Charlottesville, VA, 22902, US

(21) Appl. No.: 10/142,024

(22) Filed: May 9, 2002

Related U.S. Application Data
(62) Division of application No. 08/036,668, filed on Mar. 25, 1993.

(51) Int. Cl. D04H 1/42; D04H 1/46; D04H 1/48; B32B 5/06

(52) U.S. Cl. 442/403; 442/402; 442/407; 442/414; 442/415; 428/911; 28/103; 28/107

(57) ABSTRACT

The invention relates to a ballistic resistant material having a V50 value of at least about 1000 feet per second. The ballistic resistant material includes at least two types of fibrous materials, which are blended and consolidated together, preferably by needlepunching, to create a single layer of nonwoven, composite material. The needle punching is preferably in the range of 200 to 1000 needlepunches per square inch. The fibrous materials are characterized by being deformed when subjected to the impact of a ballistic object. One of the fibers phase changes, e.g. melting, upon impact and at least one other fiber fibrillates upon impact. One of the fibers must phase change at a temperature at least 80° C. lower than the highest melting or destruction point fiber in the high modulus fiber blend.

### FIELD OF THE INVENTION

The invention relates to a fibrous ballistic armor material having improved ballistic resistance and to the method of manufacture of the fibrous ballistic armor material.

### BRIEF DESCRIPTION OF THE PRIOR ART

Protective armor dates back before the third millennium B. C. As weapons have increased in accuracy and potency, protective armor has been forced to increased comparably. The most recent protective wear was developed with the advent of artificial fibers which are used to produce soft body armor, generally in the form of vest. Woven fabric plied in layers were able to create a barrier with relative high ballistic resistance compared to the weight of the vest. With the advancement of polymer science, higher strength fibers were developed thereby increasing the strength of the structures. The use of high tenacity Nylon, Kevlar and Spectra dramatically increased the protection per weight of the structure. Presently, the two main types of ballistic resistant fabrics are aramid woven fabrics such as Kevlar and composite Spectra Shield. Aramid is a type of polymer and the generic family of Kevlar and Nomex.

Soft body armor is given a protective rating when tested using standard projectiles traveling between 1500 and 1700 feet per second (460 and 520 m/sec). The ballistic limit, V50, represents the velocity at which complete penetration and incomplete penetration are equally likely to occur. The V50 ballistic resistance is an average velocity of six shots. The powder charge is varied to get three partial penetrations and three complete penetrations all in a 125 ft./sec range. The target has an aluminum witness plate six inches behind it. When the projectile penetrates the witness plate, the target is considered completely penetrated. The V50 ballistic resistance rating is based on three complete penetrations and three partial penetrations at projectile velocities within a125 ft./sec (38 m/sec) range of each other.

Vests using Kevlar are generally constructed of Kevlar 29 or 129 filament yarn from DuPont which is woven into a square construction (sett) of 12.2 threads/cm with 16-24 layers. This produces a vest weighing 1.5 to 2.5 kg with a V50 protective rating of 1500 to 1700 ft./sec (460 to 520 m/sec).

A combination of Kevlar 129 and Spectra Shield has been produced in some vest manufacturing. The lightweight, high strength Spectra Shield is sandwiched between layers of flame resistant, high strength Kevlar, thereby providing the vest with the individual characteristics of each fiber type. Producing these combination vests requires many steps, driving up the cost of production.

Needlepunching was used in 1966 by the U.S. Department of Defense textile testing laboratories in Natick, Mass. to produce ballistic resistant felt. It was found that a needlepunched fabric could be produced at one third the weight of a woven duck fabric while retaining 80% of the ballistic resistance. Comfort plays an important role in ballistic resistant wear, since for any material to be effective it must be worn. The soft body armor, although more comfortable than metal or leather armor, is still uncomfortable and confining. Both Kevlar woven material and Spectra Shield have low air permeability, trapping heat and limiting moisture transfer of perspiration. The prior art fabrics are stiff, limiting the movement of the wearer which may be necessary in some situations. Cost also plays a factor in the prior art in that the multiple processing steps which are required increase the product cost.

### SUMMARY OF THE INVENTION

The invention relates to a ballistic resistant device having a V50 value of at least about 1000 feet per second. The ballistic resistant device includes at least two types of fibrous materials, which are blended and consolidated together, preferably by needlepunching, to create a single layer of nonwoven, composite material. The needlepunching is preferably in the range of 200 to 1000 needlepunches per square inch. Most preferably, the range is from about 300 to 500 needlepunches per square inch.

One of the features of the invention is the use of materials which undergo deformation as a result of the impact of the ballistic object. The deformations can be in the form of phase change, as for example melting and/or fibrillation. The increased friction which takes place as the object attempts to penetrate the ballistic resistant device, produces an enhanced adsorption and dissipation of energy. While the fibrous materials has a melting point such that it melts from the heat generated by the impact of a projectile and has a higher melting or destruction point. Another aspect of the invention is the use of a materials in which the deformations are characterized by phase changes at different temperatures when subjected to the force generated by the impact of a projectile. One fiber in the blend should melt at a temperature at least 80° C. lower than the melt or decomposition point of another fiber in the blend. The higher melting or decomposing fiber(s) in the blend should decompose or melt at a temperature at least 80° C. higher than the lowest melting point fiber in the high modulus fiber blend, but not necessarily melt or decompose at temperatures within this range of variation with respect to each other where more than two fibers are present in the high modulus fiber blend. A high density polyethylene can be employed in combination with a polyaramid.

While the fiber length is not narrowly critical, at least two materials have a fiber length of approximately 3 to 4 inches. The denier per filament of the one set of fibers is advantageously in the range between 4 to 7 and the other is advantageously in the range of 1 to 3.

Preferably, the weight ratio of the first material to the second material is in the range from about 60:40 to 40:60 and the density of the two materials at 400 punches per square inch is in the range of 0.075 to 0.25 grams per cubic centimeter. The density of the at least two materials at 700 punches per square inch is in the range of 0.09 to 0.175 grams per cubic centimeter. The density of the at least two materials at 1000 punches per square inch is in the range of 0.10 to 0.25 grams per cubic centimeter.

The ballistic device of the invention is characterized by 8 layers of the material having a V50 value, using a 22 caliber projectile, of at least about 1000 feet per second. Preferably the V50 is at least 1500 feet per second. The thickness of the individual layers is dependent upon the number of punches per square inch. At 400 ppsi the thickness is 0.64 inches, at 700 ppsi the thickness is 0.057 inches and at 100 ppsi the thickness is 0.055 inches.

The method of manufacturing the composite fabric for use as a ballistic resistant device comprises the steps of blending fibers of the at least two materials, consolidating the materials together to form a single layer of composite material, and layering the single layers of composite material one over the other to form a layered composite material. The composite material is joined into an integrated structure by needlepunching the materials. Fiber to fiber friction interlocks the materials in the composite.

### BRIEF DESCRIPTION OF THE DRAWINGS

The objects and features of the present invention will more fully become apparent from the following detailed description especially when taken in connection with the drawings, wherein:

FIG. 1 is a side view of a needle punch loom;

FIG. 2 is a side view of the projectile used for testing in the instant invention;

FIG. 3 is a side view of the projectile used for testing in the instant invention;

FIG. 4 is a top view of the projectile used for testing in the instant invention

FIG. 5 is a perspective view of a crosslapper;

FIG. 6 is a comparison graph of fiber type and punch density on fabric weight;

FIG. 7 is a comparison graph of fiber type on V50 value and fabric density;

FIG. 8 is a photograph of a Kevlar fiber after impact;

FIG. 9 is a photograph of a Spectra fiber after impact;

FIG. 10 is a photograph of a cut high modulus fiber blend cone;

FIG. 11 is a chart of of the properties of needlepunched Kevlar and the high modulus fiber blend; and

FIG. 12 illustrates the deformation of the Kevlar and high modulus fiber blend fabric from a projectile test.

### DETAILED DESCRIPTION OF THE INVENTION

In order to clarify the instant disclosure, the following definitions will be used throughout. All of the following definitions have been taken from Man-Made Fiber and Textile Dictionary, Celanese corporation, 1985.

Card: A machine used in the manufacture of staple yarns. Its functions are to separate, align, and deliver the fibers in a sliver form and to remove impurities. The machine consists of a series of rolls, the surface of which are covered with many projecting wires or metal teeth. Short staple systems employ flat strips covered with card clothing rather than small rolls.

Composite Fibers: Fibers composed of two or more polymer types in a sheath-core or side-by-side (bilateral) relation.

Denier: A weight-per-unit-length measure of any linear material. Officially, it is the number of unit weight of 0.05 grams per 450-meter length . . . Denier is a direct numbering system in which the lower numbers represent the finer sizes and the higher numbers the coarser sizes.

Denier per Filament (dpf): The denier of an individual continuous filament or an individual staple fiber if it were continuous. In filament years, it is the yarn denier divided by the number of filaments.

Fabric: A planar textile structure produced by interlacing yarns, fibers, or filaments.

Fiber: A unit of material, either natural or man-made, which forms the basic element of fabrics and other textile structures. A fiber is characterized by having a length at least 100 times its diameter or width. The term refers to units which can be spun into a yarn or made into a fabric by various methods including weaving, knitting, braiding, felting, and twisting. The essential requirements for fibers to be spun into yarn include a length of at least 5 millimeters, flexibility, cohesiveness, and sufficient strength. Other important properties include elasticity, fineness, uniformity, durability, and luster.

Fibrillation: The act or process of forming fibrils. The act of breaking up a fiber, plastic sheet, or similar material into the minute fibrous elements from which the main structure is formed.

Filament: A fiber of an indefinite or extreme length such as found naturally in silk. Man-made fibers are extruded into filaments which are converted to filament yarn, staple, or tow.

Needlepunching: The process of converting batts or webs of loose fibers into a coherent nonwoven fabric on a needle loom.

Non-Woven Fabric: An assembly of textile fibers held together by mechanical interlocking in a random web or mat, by s\fusing of the fibers (in the case of thermoplastic fibers), or by bonding with a cementing medium such as starch, glue, casein, rubber, latex, or one of the cellulose derivatives or synthetic resins. Initially, the fibers may be oriented in one direction or may be deposited in a random manner. This web or sheet of fibers is bonded together by one of the methods described above. Normally, crimped fibers are used which range in length from 0.75 to 4.5 inches . . .

Polyaramid: Synthetic polymer and the fibers made from it in which the simple chemical compounds used for its production are linked together by amide linkages (—NH—CO—).

Polyethylene Fiber: A man-made fiber made of polyethylene, usually in monofilament form; . . . Ethylene is polymerized at high pressures and the resulting polymer is melt-spun and cold drawn. It may also be dry-spun from xylene solution . . . It has a low melting point, a property which has restricted its use in apparel.

Spun-Bonded Products: Nonwoven fabrics formed by filaments which have been extruded, drawn, then laid on a continuous belt. Bonding is accomplished by several methods such as by hot-roll calendering or by passing the web through a saturated-steam chamber at an elevated temperature.”

Additional definitions as used in the instant invention are as follows:

Deformation: A change in the shape of a specimen due to force or stress, such as fibrillation or phase change.

Phase change: the change of a material from one form to another form, e.g. changing a solid to a liquid through melting.

Fibers are the basis of all textile ballistic structures, and in order to provide the maximum ballistic resistance, the fiber's strength must be utilized in the most effective manner. When a projectile strikes the surface of a fabric, its energy is converted to force when the surface of the projectile makes contact with the surface of the structure. The force of impact upon a ballistic resistant fabric is absorbed along the fiber or yarn axis and at each interlacing point, where it is further dissipated. The dissipation thus occurs through the mechanisms of strain in the fiber itself and through fiber to fiber friction at the points of contact among fiber surfaces, especially at the fiber or yarn crossover points. The energy required for a material to go through a phase change can also serve to absorb or dissipate impact energy.

In a woven fabric, fiber or filament containing yarns contact each other at crossover points known as interlacings. The strain mechanism of energy absorption can be mechanically described by the material tensile behavior, which in very high strength fibers in nearly entirely Hookean in nature, thus primarily reacting as:

s=E×ε

where

s=stress, or load of force per unit area in the fiber

ε=strain, or amount of extension of the fiber resulting from the load imposed on it

E=the Young's modulus, a material characteristic which is unique to and dependent upon the chemical and physical composition of each material. If the material net cross sectional area is known, stress may be converted force.

The interlacing points require the force of a striking projectile to be further absorbed, because movement of a fiber or yarn along the body of another contacting fiber or yarn can only occur when the force necessary for movement is greater than that of the friction present. Frictional force in an interlaced fibrous structure can be estimated by the equation:

F₂=F₁e^{μΘ}

where

F₂=the force required to move fibers at the interlaced points

F₁=the inherent force present within the fabric structure which holds it together

e=the Naperian logarithmic base number, a natural constant

μ=the material coefficient of friction

Θ=the angle through which the fibers or yarns wrap around the surface of each other at interlacing.

Fabrics can be woven or nonwoven. A woven fabric is manufactured from yarns consisting of twisted fibers or assembled filaments running the width and length of the fabric and which are interwoven. A nonwoven is manufactured from fibers which are not assembled together into yarns and which are placed in the fabric structure in various directions. The fibrous web structure can be bonded together using thermal, inherent, chemical or mechanical techniques.

Most woven Kevlar fabrics exhibit yarn strength translational efficiencies between 60 and 80%, meaning that between 60% and 80% of the impact is dissipated along the fibers.

The translational efficiency is the amount of energy absorbed along the fiber axis. Strength loss is judged by how much force it takes to tear the fabric in a longitudinal or axial direction.

Only about one third of the strength loss can be attributed to reduction of strength properties by the weaving process. The remaining strength reduction, or fiber strength loss, is caused by mechanical interaction between warp and filling yarns during tensile loading. High warp crimp in a woven Kevlar structure is accompanied by low strength translation efficiency. Each time a fiber is bent over or under a transverse fiber, it loses a percentage of its strength. A compromise must be reached in fabric construction between weave density and fabric strength where neither is at an optimum level.

Fiber to fiber friction assists in absorbing energy in all fabric types while utilizing the strain wave velocity of a fibrous system. This mode of impact dissipation is most advantageously used in a nonwoven structure, because large numbers of fiber contact points are present in a nonwoven, and these may be oriented in many different directions in the structure.

Strain wave velocity is the speed at which a fiber or structure can absorb and disperse strain energy. It can be expressed as:

v=F/m

where

v=strain wave velocity

F=force applied to the fiber from the projectile

m=linear density expressed as kg/m

v can also be expressed as

V=E/ρ

where

ρ=specific gravity of material

By combining the equations, an expression for optimum dissipation of impact energy can be found, as shown by:

F=Em/ρ

The more impact energy a structure disperses, the more efficient is the energy absorption mechanism. Three reactions occur in a needlepunched structure when a projectile strikes it. The reactions are fiber strain (elongation), fiber movement (slippage) and fiber breakage. The better these features are optimized, the better the ballistic properties of the final fabric. Fiber denier and length are important when considering the fiber to fiber frictional properties within a needle punched structure. Denier is a measurement of fiber fineness defined as the mass in grams per 9000 meters of length. The smaller the denier and greater the length, the greater frictional properties can be generated in the structure. This is because more surface area will be in contact among the fibers when they are small and long. Motion in the presence of enough friction can dissipate energy through the creation of heat. The more friction generated in a structure without catastrophic fiber breakage, the more impact energy can be absorbed. A nonwoven, forces the projectile to engage many more fibers upon initial impact than a woven fabric because of the wide dispersion of filaments in the untwisted yarn.

The needlepunch fabric, as disclosed herein, can provide ballistic resistance equal to, or greater, than soft body armor of the prior art, but it can accomplish this at as little as one third the weight. Body heat transfer and vapor transfer is increased in the instant invention as well as the flexibility of the material. The instant invention also provides lower production costs because it requires low raw material usage and fewer processing steps.

The two predominant fabrics currently used for ballistic protection are polyaramid filament yarns (Kevlar) in a woven state, and Spectra Shield, a composite. Kevlar vests are generally constructed of Kevlar 29, 49 or 129 filament yarn, woven into a plain weave 31×31/inch assembly and layered 16 to 24 times, giving a weight of 3.5 to 5.5 pounds, to give the desired V50 ballistic resistance protection of 1500 to 1700 feet per second (460 to 520 meters/second). The vest normally has a thickness of 0.2 to 0.33 inches.

Spectra Shield fabric is made using two layers of unidirectional fibers bonded with resin at a 0 and a 90 degree orientation. The fabrics are layered to obtain the desired ballistic resistance. The resin binder prevents the projectile shock wave from pushing the fibers out of the projectile's path, augments the fiber strength and provides a higher translation efficiency. The Spectra Shield allows the projectile to engage many more fibers upon initial impact than a woven fabric due to the wide dispersion of filaments in the untwisted yarn. A Spectra Shield vest composed of 40 layers is approximately 0.33 inches thick and has a V50 ballistic resistance rating of approximately 1700 feet per second (518 meters/second).

A nonwoven fabric will have higher translation efficiencies than a woven fabric as it does not contain yarn interlacing points and spreads the impact energy more efficiently throughout the structure.

A blend of Spectra high density polyethylene and Kevlar polyaramid was created which has a density significantly greater than the 100% Kevlar. Spectra fibers have a larger cross section than the Kevlar fibers, so that some voids or air pockets are produced by their presence in the fabric. The smaller cross section of the Kevlar allows the Kevlar fibers to fill into the air pockets created by the presence of the Spectra fibers during the needle punching. The Spectra has a low phase change, or melting point, approximately 150° C. Kevlar fibers, by contrast, do not melt, but eventually disintegrate at very high temperatures such as 450° C.

The impact created by a bullet forces the fibers in the fabric to move against one another, creating sufficient friction to generate heat and raise the Spectra fibers above their comparatively low inherent melt point. The fibers absorb the energy concentration present with ballistic impact, dissipating it through the previously described mechanisms of strain, friction and friction-generated heat, which causes the Spectra fibers to undergo a phase change, that is, melt while they are in contact with the adjacent Kevlar fibers. The Kevlar, when struck with a projectile, fibrilates and breaks along the fiber longitudinal axis.

With needlepunching, the blend of fibers in the nonwoven is held together by surface contact friction, replacing the need for any bonding material such as that used in Spectra Shield. Chemically bonding the fabric would be difficult due to the types of materials used, however more importantly, it would not allow fiber movement in the presence of ballistic impact. The force of friction present when the fibers begin to react to the force of impact provide a rapid and efficient dispersion of the ballistic force.

The nature of the nonwoven structure provides the critical characteristic that prevents a sharp object from penetrating the fabric. In a woven fabric, a sharp object can push aside the fibers or yarns from its path and thereby penetrate the fabric. The nature of the needlepunched nonwoven prevents penetration of sharp objects in that the fibers cannot be easily moved aside due to the lack of symmetry in the fiber arrangement. This prevents sufficient layers of the fabric from being penetrated by such objects as ice picks or knives and offers increased resistance to penetration by teflon coated bullets.

Only very limited quantities of fiber were available for use in the experiment, and a large, production model N. Schlumberger et Cie./Asselin needle punch line was utilized for fabric production. The fabric samples were produced using carded and crosslapped webs. The method of carding and crosslapping was chosen because current designs of airlaying web formation equipment are not able to accommodate very stiff and strong fibers such as high density polyethylene (HDPE) or polyaramid. The spunbonding process would also be impossible to use for two reasons. Polyaramid fibers must be solution spun in the presence of sulfuric acid, and the linear character of HDPE which gives it its strength would be destroyed in melt extrusion during spunbonding.

Fabric testing was performed on each of the samples to characterize materials used and to determine if there were any fabric properties which would predict ballistic resistance. The finished fabric test results were examined using the analysis of variance (ANOVA) technique to determine if fiber length, punch density or web layers affected fabric physical or ballistic properties. Regression analysis was used to determine if fabrication parameters influenced ballistic properties.

The projectile used in the initial ballistic testing was a type 1, .22 caliber, 17 grain fragment-simulating projectile. The specifications for the projectile are defined in U.S. Military Standards MIL-P-46593A(MU), “Military Specification: Projectile, Calibers .22, .30, .50, and 20 MM Fragment—Simulating.” January, 1987, and are incorporated herein by reference. The shape of the fragment simulating projectile (FSP) is shown in FIGS. 2-4. FIGS. 2 and 3 illustrate the side views and FIG. 4 shows a top view of the FSP. Ballistic resistance was determined from three complete penetrations and three partial penetrations of samples at projectile velocities confined in the range of ±6 m/sec. The powder charge was varied to produce velocity increments of 125 feet per second to achieve the required three partial and three complete penetrations. The target had an aluminum witness plate six inches behind it to verify penetration.

Two high performance fibers were evaluated. Kevlar 29, produced by DuPont is a 1.5 denier polyaramid staple fiber with lengths of 3 and 4 inches. Spectra 1000, made by Allied Signal, is a high density polyethylene and was utilized in a 3 inch staple, 5.5 denier form. The Spectra used in the experiment was second quality fiber with tenacity and modulus values slightly lower than first quality stock.

The Spectra fiber was donated by Allied Signal for testing purposes, and was not of first quality. First quality fiber has higher breaking strength properties than second quality fiber, and would therefore provide better ballistic resistance.

A Reichert binocular microscope was utilized to subjectively evaluate the mechanism by which fibers involved in the ballistic impact were deformed. Fibers were examined and photographed under magnifications between 20 and 500 times actual fiber size. The effect of the processing conditions on fabric physical properties were evaluated by an analysis of variance (ANOVA) of a factorial experimental design. This method was chosen because it allows for a statistical study of variables as well as interactions among the variables. If the calculated p-value was below 0.05 it was deemed significant with a 5 percent risk of error level. A comparison of means (post-hoc test) was used to determine what levels of each variable had a significant effect at the 95 percent confidence level.

Regression analysis was also used in an attempt to find equations that could predict optimum processing parameters. This attempted to quantitatively determine the effects that the processing variables had on ballistic resistance.

The following objectives were arrived at determine whether the needlepunched nonwoven structure would withstand the same ballistic threats as prior art vests, whose performance characteristics are known and rated by the V50 method.

1. Evaluation of the effects of fiber length in needlepunched fabric physical and ballistic resistant properties.

2. Evaluation of the effects of punch density in needlepunched fabric physical and ballistic resistant properties.

3. Evaluation of the effects of web layers in needlepunched fabric physical and ballistic resistant properties.

4. Evaluation of the effects of Kevlar 3″ fiber, Kevlar 4″ fiber, Spectra 3″ fiber, and 50/50 blend of Kevlar 3″ and Spectra 3″, in needlepunched fabric physical and ballistic resistant properties.

5. Evaluation of the effects of changing the punch density gradient of individual layers involved in the final structure from high-low and low-high in needlepunched fabric ballistic resistant properties.

6. Developing a comparative analysis to evaluate frictional properties of the fiber types which contribute in needlepunched fabric ballistic resistant properties.

7. Develop regression equations that can be used to predict ballistic resistance as a function of varying fiber length, fiber type, punch density, web layers, fabric weight and fabric thickness.

The Spectra fiber could not be processed on the industrial card which was utilized in the experiment because of its extreme stiffness and resistance to formation into a parallel web, as required for needlepunching. Spectra is not currently produced in fiber form, so it had to be cut by Allied Signal to the specified lengths from continuous filament form. Had it been cut to a sufficient length to allow the necessary bending motions required for the carding process, it would have then been too long for the dimensions of the machine which was utilized. The carding machine used for the experiment was a new model H. Thibeau card specifically designed for the processing of nonwoven materials.

Since carding equipment capable of processing fibers of these types by themselves is not yet available, it was determined that the portion of the experiment calling for a 100% Spectra fiber nonwoven material had to be excluded from the test.

The blended fabric was composed of the two fiber types in a 50% Spectra/50% Kevlar mixture by weight. By blending 5.5 denier Spectra fiber with 1.5 denier Kevlar, it was possible to provide sufficient fiber to fiber frictional contact between the Kevlar and Spectra to bring the larger, stiffer Spectra fibers through the carding machine in a smaller population than would be present with 100% Spectra alone. Because of the limited amount of the fiber available for the experiment, a range of combinations of the two fiber types could not be attempted to determine if a smaller proportion of Kevlar could have allowed carding of more Spectra, but the beneficial effects of one of the types in the combination would have been reduced in this case.

A statistical design method was used to isolate the various effects of fiber length, punches per square inch, fabric weight, fabric density and number of layers of the fabrics on physical and ballistic resistance properties.

The final fabrics which were created were weighed and measured for thickness in the laboratories at the Institute of Textile Technology in Charlottesville, Va. From these measurements, fabric density could be determined. Ballistic resistance was measured at the laboratories of E. I. DuPont deNemours and Company in Wilmington, Del.

In keeping with the modified experimental design, three conditions of fibers were processed through an N. Schlumberger (NSC) nonwoven production line. These were: 100% Kevlar 29, 3 inch fiber; 100% Kevlar 29, 4 inch fiber; a blend of 50% Kevlar 29 and 50% Spectra 1000, both 3 inch fiber by weight.

Each of the fiber conditions was entered into the line in the desired weight proportions using a hopper feed. The fiber was transported into a blending bin, through two lattice blending apron systems, and recycled through the blending line a second time to ensure good mixing and opening of the fibers. The blending process and machinery used in the instant disclosure is well known in the prior art. The high modulus fiber blend sample was recycled a third time to achieve as close to a 50/50 blend by weight of fiber as was possible. The carding process is applied in nonwoven fabric formation to provide a web of fibers in a useful, even distribution across a width equal to that of the machine. The fibers are close to parallel in their orientation after carding.

The web was delivered from the card by apron to a crosslapper 50, illustrated in FIG. 5, where it was layered nine (9) times to give a desired predrafted weight. The crosslapper 50 is a moving apron system of conveyers which are arranged in perpendicular fashion to each other and providing a movement gradient according to speed differences between the two moving aprons. Crosslappers serve the functions of increasing the thickness of carded webs by laying layers on top of each other and of reorienting the fibers in the final web before needling so that all fibers do not lie in the same direction and a more isotropic structure can be achieved.

Webs were processed through a preneedler for stability and then given a final needling to achieve punch densities of 400, 700, 1000 penetrations per square inch (62, 109 and 155 per cm2).

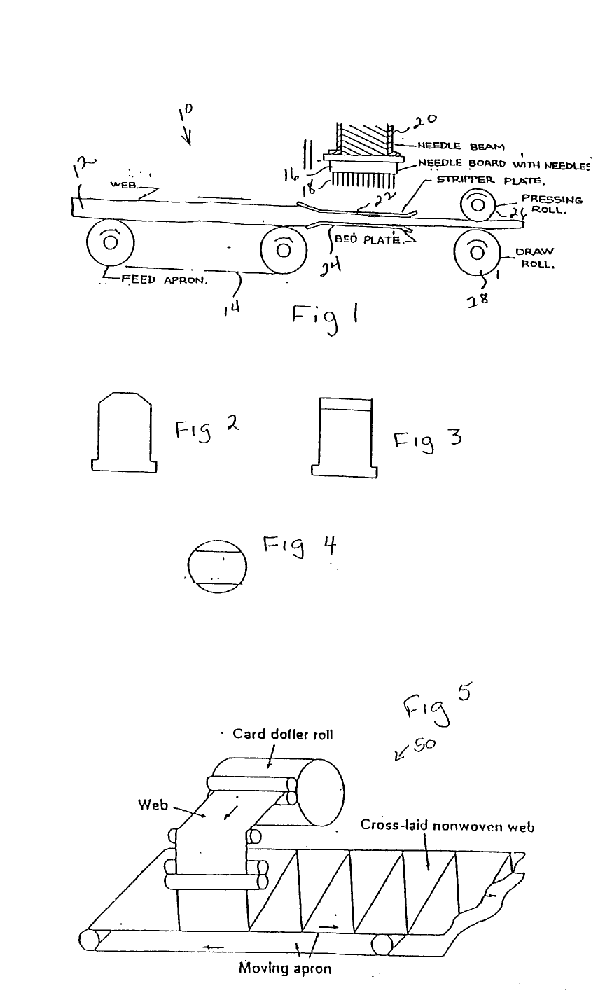

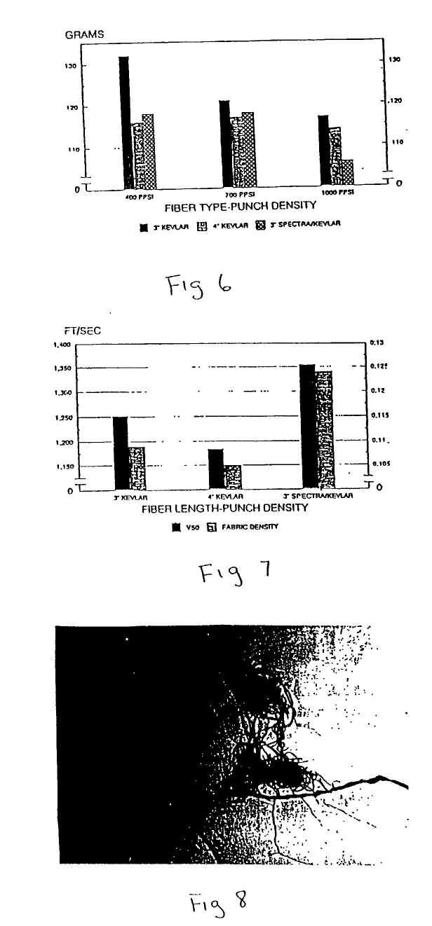

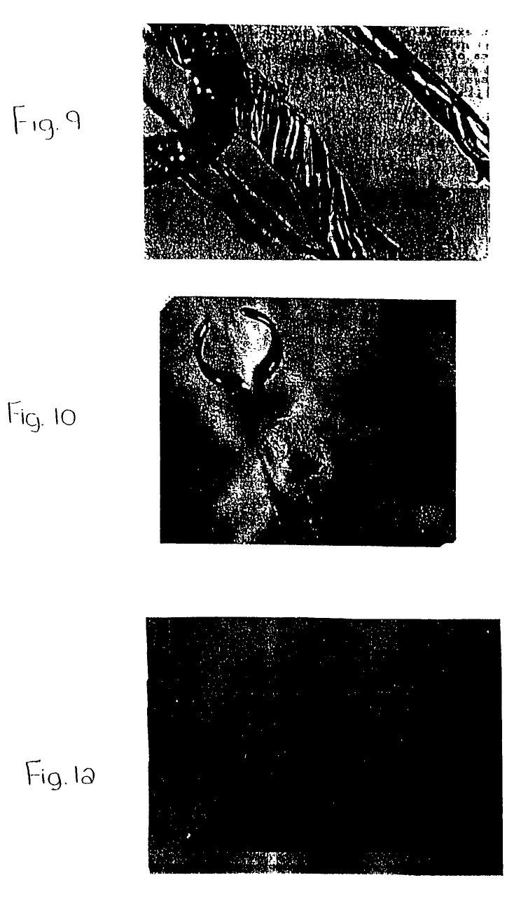

FIG. 1 illustrates a basic needlepunch loom design 10. The web 12 is the collection of uncondensed, unconsolidated fibers in the process prior to needlepunching. The web 12 is fed into the needlepunching machine 10 by the movement of the feed apron 14. The needle board 16, with the punching needles 18 in their desired patterns determines the density of needling of the fabric at each desired speed. The needle board 16 is attached to a needle beam 20, a robust structure which oscillates up and down to force the needles 18 into the moving web 12 to interlace the fibers of the web 12 among each other. The stripper plate 22 and bed plate 24 act in combination to hold and compress the web 12 together during needling and prevent the fibers from being pushed or pulled vertically out of the desired configuration of the needled fabric thickness. The pressing roll 26 and draw roll 28 act in combination to maintain the thickness of the punched fabric at a desired level while it is being pulled from the needlepunch machine 10.

The punch density or frequency of needle entry into the fabric structure can be altered during its formation, by two methods. If a desired number of punches per square inch (ppsi) is known, a needle board 16 can be specified for a certain number and arrangement to allow the maximum processing speed for the desired product. If the optimum punches per square inch is not known, as in the experiment described herein, a reasonable needle pattern for a range of ppsi is chosen and punching speed of the needlepunch machine 10 is altered to achieve a desired result.

Needlepunching holds the structure together by fiber to fiber friction alone. This technique has been effectively used since early times in fabrics such as felts for hats. It is not necessary to use chemical binders to maintain the fabric structure.

After processing, samples were cut into 28 cm×36 cm specimens and layered 4, 6 and 8 times to achieve the final structure. Structures contained either homogeneous layers of 400, 700 and 1000 punches/square inch fabric or layers in which the punch density of each layer was varied from high to low or low to high.

After layering, the structures were compressed at 3000 psi using a hydraulic press to reduce the thickness of the structure.

Kevlar

The 3″ Kevlar fiber was not significantly different from the Kevlar 4″ fiber when considering fabric weight, thickness, density and V50 ballistic resistance value.

The fiber length of the Kevlar conditions did not significantly affect the fabric thickness within a 95% confidence interval. The fiber length was also insignificant on ballistic resistance. The punch density did not significantly effect the weight of the fabric.

Increasing punch density was found to reduce fabric thickness for Kevlar fiber lengths of both 3″ and 4″, conditions. Fabric density increased as punch density was increased due to compressing increasing amounts of fiber mass into a given volume. Thickness is a determinate of the density, which is determined by the mass per cubic volume. The needle punching compresses the fibers thereby reducing the thickness while increasing the density.

Increased fabric density increased fabric ballistic resistance. The more mass compressed into a smaller volume, the higher the ballistic resistance of the fabric. Punch densities in the range of 700 to 1000 were shown to be effective for both Kevlar fiber conditions. There was significant difference between the 400 ppsi and the 700 ppsi, however the increase from 700 ppsi to 1000 ppsi produced little difference. The optimal density is reached between 700 ppsi to 1000 ppsi, thereby eliminating any need for additional needle punching beyond that point. The Kevlar 3″ fiber provided slightly greater ballistic resistance than the Kevlar 4″ fiber due to the shorter longitudinal axis, allowing the strain waves which resulted from the shock of projectile impact to more easily pass from fiber to fiber.

High Modulus Fiber Blend

The high modulus fiber blended fabric was significantly thinner than the 3″ and 4″ Kevlar alone. The thickness of the individual layers is dependent upon the number of punches per square inch. At 400 ppsi the thickness is 0.64 inches, at 700 ppsi the thickness is 0.057 inches and at 1000 ppsi the thickness is 0.055 inches. The denier differences between the Kevlar alone and the Spectra/Kevlar contributed substantially to the differences in thickness. The Spectra fibers used in the blend were 5.5 dpf while the Kevlar were 1.5 dpf. The higher denier of the Spectra fibers provided more voids in the blended needlepunched samples as compared to the 100% Kevlar. When pressed, the additional space provided by the voids compacted more easily and recovered less than the 100% Kevlar. Taking into consideration the specific gravity and denier differences between the Kevlar and Spectra, there was 37% less fiber present in the blended samples than in the 100% Kevlar. The blended fabric consisted of 27% Spectra and 73% Kevlar, by numerical population of fibers.

The punch density greatly affected the thickness of the fabric, which decreased as the punch densities increased. As the fabric was needled to higher punch densities it condensed into a more compact structure. At 400 ppsi, the density in grams per cubic centimeter was less than 0.105. At 700 ppsi the density was 0.115 grams/cubic cm and at 1000 ppsi the density was approximately 0.150 grams/cubic cm.

The increased density of the fabric provides the increased ballistic resistance as measured by V50. FIG. 6 illustrates the relationship determined for fiber type and punch density applied. As fewer punches per square inch are required for the desired fabric properties, manufacturing costs for this step are reduced in direct proportion.

FIG. 7 is a comparison of fiber type and punch density on fabric weight. The figure shows the results of tests of the fabric characteristics after various stages of needlepunching for each condition present. Fabric weight decreased for high modulus fiber blended fabric with increasing punch density. This result indicates that the strong, stiff fibers of both types which were present in the high modulus fiber blend were pushed out of the needling area, probably in the counter process flow direction rather than being interlaced as intended. This effect was particularly to be noted at needling densities above 400 ppsi. The weight of the high modulus fiber blend had no significant variation with respect to the 100% Kevlar fabrics.

The high modulus fiber blend provided the greatest ballistic resistance of the fabrics tested. The Spectra fiber denier and specific gravity must be taken into consideration when evaluating the differences between the blended and Kevlar conditions. As shown in Equation 3, individual Spectra fibers were approximately six times stronger than individual Kevlar fibers. Prior research has shown that increased fiber strength produces higher V50 ballistic resistance values in a needlepunched structure. Laible, R. D. , Methods and Phenomena 5, Ballistic Materials and Penetration Mechanics. Elsevier Scientific Publishing company, Inc., Amsterdam. 1980. Ipson, T. W. , Wittrock, E. P. Response of Nonwoven Synthetic Fiber Textiles to Ballistic Impact. Technical Report No. 67-8-CM U.S. Army Natick Laboratories, Natick, Mass. July, 1966. Laible, R. C. , Henry, M. C. A Review of the Development of Ballistic Needle-Punched Felts. Technical Report No. 70-32-CE. U.S. Army Natick Laboratories, Natick, Mass. October, 1969.

The high modulus fiber blend showed an increase of V50 ballistic resistance values as the punch density approached 400 ppsi. The optimum value for punches per square inch lie between 400 and 700, however the difference between the 400 and 700 psi is slight. Punch densities of 400 ppsi and 700 ppsi were not significantly different from one another. They were significantly higher ballistic resistance than 1000 ppsi.

The number of web layers present provided a source of variation for ballistic resistance in the 100% Kevlar. The resistance increased at the 4 to 8 layers range, with 8 layers yielding results equal to 30 layers of Spectra Shield and 24 layers of Kevlar.

The number of web layers had less effect in the high modulus fiber blends. As the number of layers increased, the differences between the blended and the 100% Kevlar decreased, however the high modulus fiber blend still retained higher ballistic resistance in comparison. FIG. 11 illustrates the various properties of the needlepunched Kevlar and high modulus fiber blend.

The variation in density obtained through added layers showed a similar response of V50 ballistic resistance ballistic resistance with varying fabric density for the different fiber type conditions. The greater the number of layers, the higher the density and the higher the V50 resistance. The effect on the weight of the vest was in proportion to the number of layers of fabric added. The thickness of the vest, however, was affected by the addition of air space between the layers.

When combining layers of different punch densities, changing the punch density gradient of the layers did not provide for significant variation of ballistic resistance. with respect to projectile penetration differences, it was apparent that there were no differences in the arrangement of the two density gradients.

Fiber deformation mechanisms are different for the Kevlar and Spectra fibers. Microscopic evaluation of Kevlar fibers showed that the fibers fibrillated under impact while the Spectra fibers were deformed by melting and deformation. FIG. 8 illustrates a fibrillated Kevlar fiber, magnified 150 times, after impact by a projectile. In contrast, the Spectra fiber, FIG. 9, magnified 375 times, has been deformed due to the heat created by the impact of the projectile. These Figures are discussed in more detail further herein. The combination of the high modulus fiber blend provided a more effective energy absorbing structure.

Regression analysis showed that punch density, fiber type, fabric weight and fabric thickness could all be good predictors of ballistic resistance.

Two separate modes were present by which the Kevlar and the Spectra/Kevlar fabrics were deformed under ballistic impact. These mechanisms were evaluated in the experiment by subjective and objective means.

The objective evaluation incorporated fiber properties into relations which could be used to examine differences in V50 ballistic resistance values. A value was derived which was called the “additive fiber strength” and is defined as the total of all individual fiber tenacities in a given structure. The additive fiber strength of the high modulus fiber blend was 38% greater than that of the 100% Kevlar sample. This result is an indicator of the differences in ballistic resistance among the fiber condition types.

To estimate the cumulative fiber strength of a structure, the total number of fibers in the structure was first calculated. By knowing fiber denier, fiber length and fabric weight, the total number of fibers in each fabric could be determined. Additive fiber strength is a measure of each of the individual fiber tenacities summed over the structure. This result gives an indication of the proportion to which each fiber type adds to strength of the fabric.

The “additive fiber strength” number is intended to quantify empirically differences between V50 ballistic resistance values of the 100% Kevlar conditions and the blended conditions. It should be noted that this factor could only be considered useful if fiber slippage was hindered to the extent that fiber locking was present and fiber breakage began to occur. It was apparent from fabric evaluation that the conditions examined in the experiment met this criterion.

The subjective analysis involved use of photographs of fabrics and individual fibers in an attempt to explain the V50 ballistic resistance differences. The fiber deformation mechanism for the two fiber conditions was observed to be different.

FIG. 8 is a typical Kevlar fiber that was in the area of ballistic impact. It can be seen that the fiber destruction mechanism was fibrillation or splitting of the fiber along its axis. The same extent of fiber fibrillation was not observed in the region outside the impact area of the projectile.

Kevlar fibers are highly heat resistant, and therefore do not melt from the heat resulting from fiber-fiber or fiber-fragment friction. Kevlar fibers deformed exclusively through the mechanism of fibrillation. The fibers continually were displaced until they locked, and broke up to the point when the fabric absorbed the projectile energy or the projectile exited the structure. If exit occurred, a segment of the original fabric structure consisting of loose fibers was pulled out of the needlepunched, impacted configuration.

The Spectra fibers were observed to deform differently from the Kevlar. The imprints of fibers that were pulled across the surface of another is shown in FIG. 9. The photograph gives evidence that the surface temperature of the fiber was raised to the point that it was softened and permanently deformed.

Since the fiber was heated to the melt point, substantial energy was locally expended at the fiber crossover to produce a state change in the polyethylene fiber. As the bullet penetrated through the layers, more fibers were pulled across each other at very high rates of speed expending more heat energy by fiber to fiber friction and changes of state. This energy absorbing mechanism produced some of the increase in V50 ballistic resistance values found in the high modulus fiber blend compared to the values encountered with 100% Kevlar.

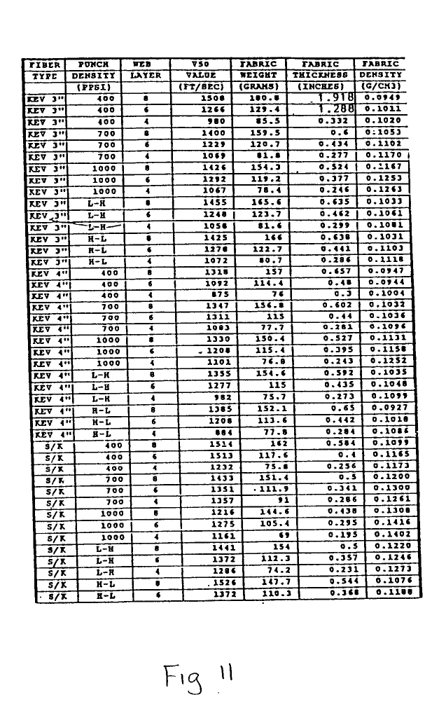

The effects of fiber-fragment friction can be seen in FIG. 10. This sample was taken from the middle layer of a high modulus fiber blended structure that stopped a fragment. The arrow points to the actual fragment and the area around the fragment where the fabric had been cut cleanly. This revealed that the edge of the fragment and the fibers in contact with this edge, were heated up to the point where the Spectra fibers were flattened by the combination of attaining the fibers' melting points and the force of the fragment impact energy.

In FIG. 12 the difference in deformation is illustrated between the high modulus fiber blend and the 100% Kevlar. As can be seen from FIG. 11, the high modulus fiber blend deformed approximately ¾ inch beyond the top layer, in comparison to the Kevlar which deformed approximately 2¾ inches beyond the top layer. In both instances the projectile was defeated when the fiber to fiber friction and fiber breakage energy was great enough to absorb the impact energy of the projectile. The high modulus fiber blend is advantageous in that the fiber only deformed the ¾ inches prior to stopping the projectile in comparison to the 2¾ inch penetration of the Kevlar. When taking into consideration that any penetration beyond the top layer starts engaging the wearer's clothing and/or body, the difference between the two penetrations can mean the difference between life and death.

The fibers referred to herein, Spectra and Kevlar are specific fibers used for ballistic resistance. They can, however be substituted in the high modulus fiber blend disclosed herein, by any fibers having the desired properties. One fiber in the blend should melt at a temperature at least 80° C. lower than the melt or decomposition point of another fiber in the blend. The higher melting or decomposing fiber(s) in the blend should decompose or melt at a temperature at least 80° C. higher than the lowest melting point fiber in the high modulus fiber blend, but not necessarily melt or decompose at temperatures within this range of variation with respect to each other where more than two fibers are present in the high modulus fiber blend. It is important for the most widely variant fiber melt points to be at least as great as indicated. The advantage of one material melting and one material fibrillating is the provision of flame and heat resistance. Both materials melting would tend to retain a large quantity of heat, making additional clothing subject to catching fire or, at the least, burning the user.

It is not important for the blend which fiber has the higher modulus or tenacity. Fiber tenacities should be at least 18 grams load per denier with modulus values of at least 475 grams per denier for any fiber type present. The tenacity is the grams or centi-Newtons of load required to break a fiber when applied axially and normalized according to the linear density of the fiber which is present. Conventionally, tenacity is expressed as grams per denier or centi-Newtons per tex, where denier is the grams mass present per 9000 meters of length and tex is the grams mass present per 1000 meters of length. In the instant disclosure these were 20 gf to 40 gf. The stiffness or modulus, is expressed in either grams load/denier or centi-Newtons/tex and in the instant disclosure is between 500-2000 grams force/denier.

The fiber composition by weight of a two fiber high modulus fiber blend should be in the range of between 40% and 60% of one fiber and, Conversely, 60% to 40% of the other. If three or more fiber types are used, melt point, tenacity and modulus restrictions apply. In this case, blend ranges can be in any proportion such that sum of the percentage of each fiber type present totals 100.

What is claimed is:

1. A ballistic resistant device having a V50 value of at least about 1000 feet per second, said ballistic resistant device comprising at least two types of fibrous materials, said two types of material being blended and consolidated together to create a single layer of composite material, said at least two types of fibrous materials being characterized by being deformed when subjected to the impact of a ballistic object.

2. The ballistic device of claim 1, wherein said composite material is a nonwoven fabric.

3. The ballistic device of claim 1, wherein said first of at least two materials is a high density polyethylene.

4. The ballistic device of claim 1, wherein said said second of at least two materials is a polyaramid.

5. The ballistic device of claim 1, wherein said at least two types of material are consolidated by needlepunching.

6. The ballistic device of claim 5, wherein said composite material has in the range of 200 to 1000 needlepunches per square inch.

7. The ballistic device of claim 6, wherein said composite material has in the range of 300 to 500 needlepunches per square inch.

8. The ballistic device of claim 1, wherein one of said at least two materials has a fiber length of approximately 3 to 4 inches.

9. The ballistic device of claim 1, wherein one of said at least two materials has a melting point such that it melts from the heat generated by the impact of a projectile.

10. The ballistic device of claim 1, wherein one of said at least two materials is characterized by fibrillating when subjected to the force generated by the impact of a projectile.

11. The ballistic device of claim 1, wherein the denier per filament of said first material is in the range between 4 to 7.

12. The ballistic device of claim 1, wherein the denier per filament of said second material is in the range of 1 to 3.

13. The ballistic device of claim 1, wherein the weight ratio of said first material to said second material is in the range from about 60:40 to 40:60.

14. The ballistic device of claim 5, wherein the density of said at least two materials at 200-1000 punches per square inch is in the range of 0.075 to 0.25 grams per cubic centimeter.

15. The ballistic device of claim 15, wherein 8 layers of said material has a V50 value, using a 22 caliber projectile, of at least about 1000 feet per second.

16. The ballistic device of claim 5, said device being formed of a plurality of layers of said composite material, at least a plurality of said layers being needlepunched in the range from about 200 to about 1000 punches per square inch.

17. The ballistic device of claim 1, wherein one of said at least two materials upon impact goes through a phase change at a temperature at least 80° C. lower than the other of said at least two materials.

18. The ballistic device of claim 16, wherein said phase change is in the form of melting, thereby increasing fiber to fiber friction at the points of contact of fiber surfaces.

19. The ballistic device of claim 1, wherein said deformation of one of said at least two fabrics is in the form of fibrillating.

20. The ballistic device of claim 1, wherein said at least two materials has a fiber tenacity of at least 18 grams of load per denier.

21. The ballistic device of claim 20, wherein said at least two materials has a fiber tenacity of between 20 and 40 grams of load per denier.

22. The ballistic device of claim 1, wherein said at least two materials has a modulus value of from about 500 to about 2000 grams force per denier.

23. The method of manufacturing a composite fabric for use as a ballistic resistant device with a V50 value of at least 1200 feet per second, said composite fabric being formed from at least two different types of material, said at least two materials being characterized by being deformable by the ballistic impact energy, comprising the steps of:
blending fibers of said at least two materials;
consolidating said materials together to form a single layer of composite material,
layering said single layers of composite material one over the other to form a layered composite material.

24. The method of manufacturing the ballistic resistant composite material of claim 23, wherein the said composite material is compressed under a load of at least about 2000 psi.

25. The method of manufacturing the ballistic resistant composite material of claim 23, wherein one of said materials is substantially resistant to deformation by the impact of a projectile.

26. The method of manufacturing the ballistic resistant composite of claim 25, wherein one of said materials has a phase change temperature within the temperature range produced by the heat generated by the impact of a projectile.

27. The method of manufacturing a ballistic resistant composite material of claim 26, wherein one of said materials has a phase change temperature substantially above the temperature range produced by the heat generated by the impact of a projectile.

28. The method of manufacturing a ballistic resistant composite material of claim 26, wherein one of said at least two materials deforms at a temperature at least 80° C. lower than the second of said at least two materials.

29. The method of manufacturing a ballistic resistant composite material of claim 26, wherein one of said at least two materials phase changes by melting from the heat created upon impact of a projectile.

30. The method of manufacturing a ballistic resistant composite material of claim 25, wherein one of said at least two materials enters a phase change from the heat created upon impact of a projectile and one of said at least two materials does not enter a phase change from the heat created upon impact of a projectile.

31. The method of manufacturing a ballistic resistant composite material of claim 25, wherein one of said materials fiberlates from the force created upon impact of a projectile.

32. The method of manufacturing a ballistic resistant composite material of claim 25 wherein the method of joining said composite materials is by needlepunching said materials, whereby fiber to fiber friction interlock said materials in composite.

33. The method of manufacturing a ballistic resistant composite material of claim 32 wherein said composite is needlepunched at least about 200 punches per square inch.

34. The method of manufacturing a ballistic resistant composite material of claim 25, wherein the denier per filament of one of the materials is in the range between 4 to 7.

35. The method of manufacturing a ballistic resistant composite material of claim 25, wherein the denier per filament of one of the materials is in the range between 1 to 3.

36. The method of manufacturing a ballistic resistant composite material of claim 25, wherein said at least two materials have a fiber tenacity of at least 18 grams per load per denier.

37. The method of manufacturing a ballistic resistant composite material of claim 36, wherein said at least two materials have a fiber tenacity of between 20 and 40 grams per load per denier.

38. The method of manufacturing a ballistic resistant composite material of claim 25, wherein said at least two materials has a modulus value in the range from about 500 to about 2000 grams force per denier.

39. The method of sorption and dissipation of energy of a ballistic object, comprising forming a ballistic resistant composite fabric for stopping an object, said composite fabric having at least two types of fibrous materials, said materials being deformed by teh impact of a projectile, dissipating ballistic impact by said deformation said at least two materials, whereby ballistic energy undergoes sorption and dissipation upon deformation and interfiber friction is increased by said deformation.

40. The method of claim 39, wherein said at least one fibrous materials undergoes a phase change within the temperature range produced by the heat generated by the impact of said ballistic object.

41. The method of claim 39, wherein said at least one fibrous materials does not undergo a phase change within the temperature range produced by the heat generated by the impact of said ballistic object.

42. The method of claim 39, wherein said at least one fibrous materials deforms by fibrillation upon impact of said ballistic object.

43. The method of claim 39, wherein said at least one fibrous materials undergoes a phase change within the temperature range produced by the heat generated by the impact of said ballistic object and said another of said at least two materials undergoes deformation at an impact at a temperature at least 80° C. higher than that of the other at least two materials.
